(19) United States
(12) Patent Application Publication
(10) Pub. No.: US 2020/0406530 A1
(43) Pub. Date: Dec. 31, 2020

(54) GLASS BLOWING ADDITIVE MANUFACTURING DEVICE

(71) Applicant: International Business Machines Corporation, Armonk, NY (US)

(72) Inventors: Andrew Hicks, Wappingers Falls, NY (US); Miles C. Pedrone, Wappingers Falls, NY (US); Tynan J. Garrett, Poughkeepsie, NY (US); Michael Peter Lyons, Arlington, MA (US)

(21) Appl. No.: 16/453,659

(22) Filed: Jun. 26, 2019

(51) Int. Cl. B29C 64/106; B29C 64/209; B29C 64/25; B29C 64/245; B29C 64/241; B29C 64/379; C03B 9/32

(52) U.S. Cl. CPC B29C 64/106; B29C 64/209; B29C 64/25; B33Y 30/00; B29C 64/241; B29C 64/379; C03B 9/32; B29C 64/245

(57) ABSTRACT

An additive manufacturing device is provided and includes a housing, a printing bed, a printing head and a controller. The printing bed is rotatably disposed in the housing and includes a surface and a body. The body defines an air conduit terminating at an open end at the surface and is fluidly communicative with an exterior of the housing. The printing head is movably disposed in the housing and configured to print molten glass material onto the printing bed at a location corresponding to the open end of the air conduit. The controller is configured to control movements and printing operations of the printing head, rotations of the printing bed and airflow to the molten glass material through the air conduit.

### BACKGROUND

The present invention generally relates to additive manufacturing devices, and more specifically, to a glass blowing additive manufacturing device.

Additive manufacturing, or three-dimensional (3D) printing, is typically conducted in a 3D printer or another similar device and involves the deposition and curing or hardening of material in patterned layers to form a 3D printed object. Most 3D printers include a housing, a printing bed disposed in the housing, a printing head, nozzle or dispenser that dispenses the material onto the printing bed and then onto subsequent layers, a curing or hardening element that cures or hardens the material and a controller system. The control system controls the position and orientation of the printing head, nozzle or dispenser as well as the position and orientation of the curing or hardening element. In this way, the 3D printed object can be provided with various, oftentimes complex geometries.

### SUMMARY

Embodiments of the present invention are directed to an additive manufacturing device. A non-limiting example of the additive manufacturing device includes a housing, a printing bed, a printing head and a controller. The printing bed is rotatably disposed in the housing and includes a surface and a body. The body defines an air conduit terminating at an open end at the surface and is fluidly communicative with an exterior of the housing. The printing head is movably disposed in the housing and configured to print molten glass material onto the printing bed at a location corresponding to the open end of the air conduit and onto successive layers of previously printed molten glass material. The controller is configured to control movements and printing operations of the printing head, rotations of the printing bed and airflow to the molten glass material through the air conduit.

Embodiments of the present invention are directed to an additive manufacturing device. A non-limiting example of the additive manufacturing device includes a housing, a printing bed rotating element, a printing bed, a track, a printing head, a pump and a controller. The printing bed is disposed in the housing and is rotatable by the printing bed rotating element. The printing bed includes a surface and a body. The body defines an air conduit terminating at an open end at the surface and being fluidly communicative with an exterior of the housing. The printing head is disposed in the housing, is supported by the track to be movable relative to the printing bed in multiple directions and multiple degrees of freedom and is configured to print molten glass material onto the printing bed at a location corresponding to the open end of the air conduit. The pump is configured to pump air through the air conduit toward the open end. The controller is configured to operate the track and the printing head, the printing bed rotating element and the pump.

Embodiments of the present invention are directed to a method of automatically operating an additive manufacturing device. A non-limiting example of the method includes printing molten glass material onto a printing bed, rotating the printing bed, pumping air into the molten glass material and manipulating the molten glass material into a predefined shape.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a side schematic view of an additive manufacturing device in accordance with embodiments of the present invention;

FIG. 2 is an enlarged side view of a printing bed of the additive manufacturing device of FIG. 1 in accordance with embodiments of the present invention;

FIG. 3 is a side schematic view of an additive manufacturing device in accordance with embodiments of the present invention;

FIG. 4 is a schematic diagram of a controller of the additive manufacturing devices of FIG. 1 or 3 in accordance with embodiments of the present invention; and

FIG. 5 is a flow diagram illustrating a method of operating an additive manufacturing device in accordance with embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

As will be described below, an additive manufacturing device is provided. The additive manufacturing device includes a housing, a printing bed, a printing head and a controller. The printing bed is rotatably disposed in the housing and includes a surface and a body. The body defines an air conduit terminating at an open end at the surface and is fluidly communicative with an exterior of the housing. The printing head is movably disposed in the housing and configured to print molten glass material onto the printing bed at a location corresponding to the open end of the air conduit. The controller is configured to control movements and printing operations of the printing head, rotations of the printing bed and airflow to the molten glass material through the air conduit.

3D printers and additive manufacturing devices in general are made up of a few different parts such as the extruder head and a print bed. The extruder head adds material to the print bed corresponding to a predefined model. Typically, additive manufacturing devices use plastic materials such as PLA, ABS or PVA to create objects but, recently, there have been additive manufacturing devices brought into the market that purport to print glass. The issues with some of these devices is that the material, when printed, cannot form beautiful shapes as one would see in an art museum or even as a home decoration. The imperfections that cause this are the lack of smoothness on the object, the thickness of the material that can be added and the inability of a standard additive manufacturing device, even one that can print glass, to manipulate the glass past deposition of the material.

One or more embodiments of the invention provide for an additive manufacturing device that can print glass in such a way as to avoid the formation of an object with imperfections such as a lack of smoothness and uncontrolled thicknesses where the object can be manipulated into a predefined shape.

One or more embodiments of the invention provide an additive manufacturing device in which molten glass material can be printed onto a rotatable surface through which air can be blown into the glass. With the molten glass material remaining in the molten state, the rotations of the surface and the airflow into the molten glass material create a bulb that can be manipulated and shaped.

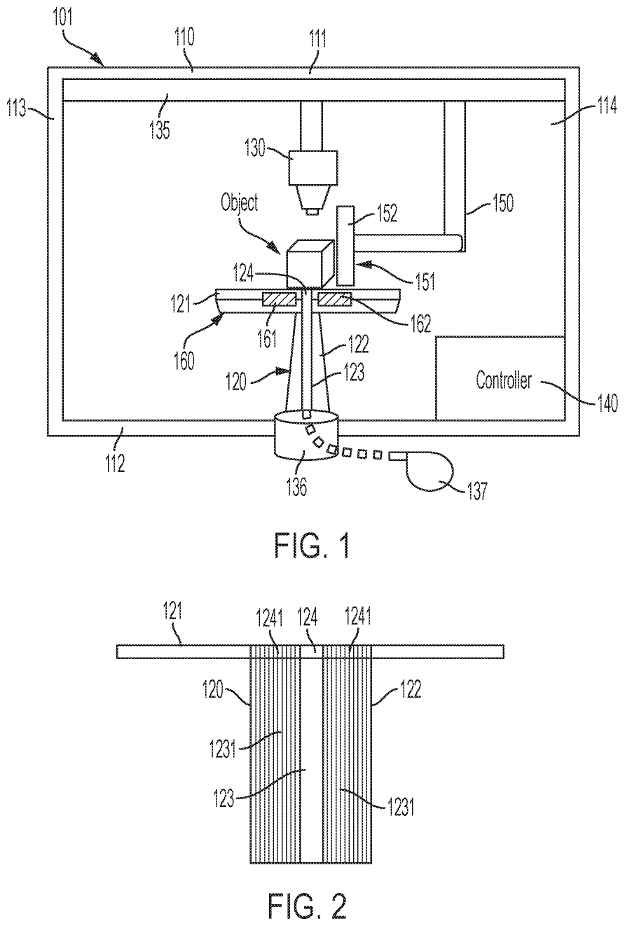

Turning now to a more detailed description of aspects of the present invention, FIG. 1 depicts an additive manufacturing device 101 in accordance with one or more embodiments of the present invention. The additive manufacturing device 101 includes a housing 110, a printing bed 120, a printing head 130 and a controller 140. The housing 110 has a top 111, a bottom 112 and sidewalls 113 supporting the top 111 above the bottom 112 to define an interior 114. The printing bed 120 is rotatably disposed in the interior 114 of the housing 110 and includes a surface 121 and a body 122. The body 122 is formed to define an air conduit 123 that extends from an exterior of the housing 110, through the body 122 and terminates at an open end 124 at the surface 121. The surface 121 is formed to define the open end 124. Thus, the air conduit 123 is fluidly communicative with the exterior of the housing 110 and the open end 124. The printing head 130 is movably disposed in the interior 114 of the housing 110 and is configured to print molten glass material onto the surface 121 of the printing bed 120 at a location that corresponds to the open end 124 of the air conduit 123. The controller 140 is configured to control movements and printing operations of the printing head 130, rotations of the printing bed 120 and airflow to the molten glass material through the air conduit 123.

In accordance with embodiments of the present invention, the additive manufacturing device 101 can further include a track 135, a printing bed rotating element 136 and a pump 137. The track 135 is configured to support the printing head 130 in the interior 114 of the housing 110. The controller 140 is operably coupled to the track 135 such that the track 135 is controllable by the controller 140 to move the printing head 130 in multiple directions and with multiple degrees of freedom relative to the printing bed 120. The printing bed rotating element 136 can include or be provided as a motor and is configured to rotate the printing bed 120 (i.e., to rotate the surface 121) at one or multiple and varying rotational speeds. The controller 140 is operably coupled to the printing bed rotating element 136 such that the printing bed rotating element 136 is controllable by the controller 140 to execute rotations of the printing bed 120. The pump 137 can include or be provided as a blower and is configured to pump air through the air conduit 123 toward the open end 124 at one or multiple and varying air pressures. The controller 140 is operably coupled to the pump 137 such that the pump 137 is controllable by the controller 140 to execute pumping.

With reference to FIG. 2 and, in accordance with further embodiments of the present invention, the surface 121 of the printing bed 120 can be formed to define the open end 124 and additional open ends 1241 as well. In these or other cases, the body 122 can be formed to define the air conduit 123 and additional air conduits 1231 terminating at corresponding ones of the additional open ends 1241 at the surface 121 and being fluidly communicative with the exterior of the housing 110. Here, the pump 137 can be controlled by the controller 140 to pump air into any one or more of the air conduit 123 and the additional air conduits 1231 such that air can be blown into the molten glass material at multiple locations (i.e., at the multiple locations of each of the activated ones of the air conduit 123 and the additional air conduits 1231).

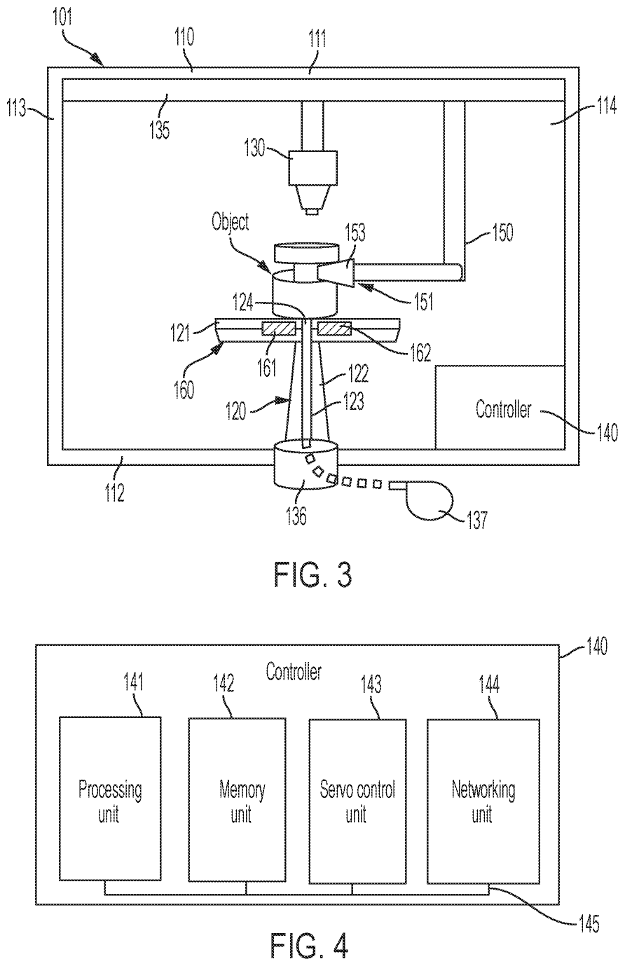

With reference back to FIG. 1 and with additional reference to FIG. 3, the additive manufacturing device 101 can further include a modification arm 150. The modification arm 150 is controllable by the controller 140 to manipulate a modification feature 151 in multiple directions and with multiple degrees of freedom relative to the printing bed 120. The modification feature 151 is attachable to a distal end of the modification arm 150. In accordance with further embodiments, the modification feature 151 can include one or more of a glass smoothing tool 152 (see FIG. 1) and a glass crimping tool 153 (see FIG. 3).

In the case of the modification feature 151 being the glass smoothing tool 152 as shown in FIG. 1, during an operation of the additive manufacturing device 101 where the molten glass material has been printed onto the surface 121 of the printing bed 120 and expanded by air blown into it through the air conduit 123 and the open end 124, the glass smoothing tool 152 can be brought into contact with a side of the molten glass material by the modification arm 150. A smooth contact surface of the glass smoothing tool 152 can then smooth out side surfaces of the molten glass material as the jog rotating element 136 rotates the printing bed 120 and the molten glass material.

In the case of the modification feature 151 being the glass crimping tool 153 as shown in FIG. 3, during an operation of the additive manufacturing device 101 where the molten glass material has been printed onto the surface 121 of the printing bed 120 and expanded by air blown into it through the air conduit 123 and the open end 124, the glass crimping tool 153 can be brought into a proximity of the molten glass material by the modification arm 150 whereby the glass crimping tool 153 can be operated to crimp (and pull and otherwise manipulate) the molten glass material.

With continued reference to FIGS. 1 and 3, the additive manufacturing device 101 can further include a thermal management system 160. The thermal management system 160 can include one or more heating elements 161 configured to maintain the molten glass material in a molten state and one or more cooling elements 162 configured to cool the molten glass material. The thermal management system 160 is operably coupled to the controller 140 and is thus controllable by the controller 140 to maintain the molten glass material in the molten state or to cool the molten glass material.

With reference to FIG. 4, the controller 140 can be provided as a local or remote component of the additive manufacturing device 101 and can include a processing unit 141, a memory unit 142, a servo control unit 143 which is configured to operate the various components of the additive manufacturing device 101 in accordance with command issued by the processing unit 141, a networking unit 144 by which the processing unit 141 is communicative with various position-sensing and/or heat-sensing sensors of the additive manufacturing device 101 and external computing resources and an input/output (I/O) bus 145. The processing unit 141 is communicative with the memory unit 142, the servo control unit 143 and the networking unit 144 by way of the I/O bus 145. The memory unit 142 has data and executable instructions stored thereon, which are readable and executable by the processing unit 141. When the data and the executable instructions are read and executed by the processing unit 141, the executable instructions cause the processing unit 141 to operate as described herein.

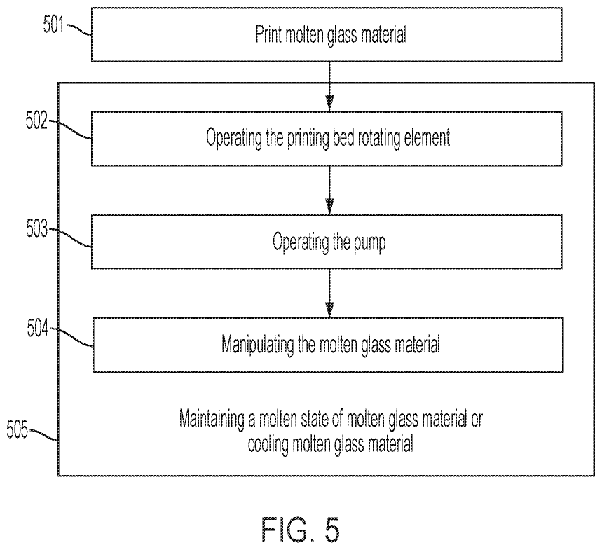

With continued reference to FIGS. 1 and 3 and with additional reference to FIG. 5, a method of automatically operating the additive manufacturing device 101 is provided and can be executable by the processing unit 141. As shown in FIG. 5, the method includes operating the printing head 130 to print molten glass material onto the surface 121 of the printing bed 120 (block 501) at or proximate to one or more of the open end 124 and/or the additional open ends 1241 (see FIG. 2). The method further includes operating the printing bed rotating element 136 to rotate the printing bed 120 (block 502) and the pump 137 to pump air into the molten glass material (block 503) through one or more of the air conduit 123 and/or the additional air conduits 1231 (see FIG. 2). In addition, the method can include operating the modification arm 150 and the modification feature 151 to manipulate the molten glass material into a predefined shape (block 504) by one or more of smoothing and crimping. The method can also include operating the thermal management system 160 to maintain the molten glass material in a molten state during the printing, the rotating, the pumping and the manipulating or to cool the molten glass material (block 505).

The data stored in the memory unit 142 can be a computer-aided design (CAD) of an object or another similar file that defines a size, shape and various other dimensions of the object. The processing unit 141 reads the data and executes the operations of the method of FIG. 5 accordingly. For each operation, the processing unit 141 can communicate with the various position-sensing and/or heat-sensing sensors in closed or open feedback control loops. For example, the processing unit 141 can rely upon position-sensing sensors in the control of the printing head 130 and the modification arm 150. Similarly, the processing unit 141 can rely upon heat-sensing sensors in the control of the thermal management system 160.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. An additive manufacturing device, comprising:
a housing;
a printing bed rotatably disposed in the housing and comprising a surface and a body, the body defining an air conduit terminating at an open end at the surface and being fluidly communicative with an exterior of the housing;
a printing head movably disposed in the housing and configured to print molten glass material onto the printing bed at a location corresponding to the open end of the air conduit; and
a controller configured to control movements and printing operations of the printing head, rotations of the printing bed and airflow to the molten glass material through the air conduit.

2. The additive manufacturing device according to claim 1, further comprising a track configured to support the printing head and controllable by the controller to move the printing head in multiple directions and with multiple degrees of freedom relative to the printing bed.

3. The additive manufacturing device according to claim 1, further comprising a printing bed rotating element configured to rotate the printing bed and controllable by the controller to execute the rotations of the printing bed.

4. The additive manufacturing device according to claim 3, wherein the printing bed rotating element is capable of rotating the printing bed at various rotational speeds.

5. The additive manufacturing device according to claim 1, further comprising a pump configured to pump air through the air conduit toward the open end and controllable by the controller to execute pumping.

6. The additive manufacturing device according to claim 5, wherein the pump is capable of pumping the air through the air conduit toward the open end at various air pressures.

7. The additive manufacturing device according to claim 1, wherein:
the surface is formed to define the open end and additional open ends, and
the body is formed to define the air conduit terminating at the open end at the surface and being fluidly communicative with an exterior of the housing and additional air conduits terminating at corresponding ones of the additional open ends at the surface and being fluidly communicative with the exterior of the housing.

8. The additive manufacturing device according to claim 1, further comprising a modification arm, which is controllable by the controller, to manipulate a modification feature in multiple directions and with multiple degrees of freedom relative to the printing bed.

9. The additive manufacturing device according to claim 8, wherein the modification feature comprises one of a glass smoothing tool and a glass crimping tool.

10. The additive manufacturing device according to claim 1, further comprising a thermal management system configured to maintain the molten glass material in a molten state.

11. An additive manufacturing device, comprising:
a housing;
a printing bed rotating element;
a printing bed disposed in the housing and rotatable by the printing bed rotating element, the printing bed comprising a surface and a body and the body defining an air conduit terminating at an open end at the surface and being fluidly communicative with an exterior of the housing;
a track;
a printing head disposed in the housing, supported by the track to be movable relative to the printing bed in multiple directions and multiple degrees of freedom and configured to print molten glass material onto the printing bed at a location corresponding to the open end of the air conduit;
a pump configured to pump air through the air conduit toward the open end; and
a controller configured to operate the track and the printing head, the printing bed rotating element and the pump.

12. The additive manufacturing device according to claim 11, wherein the printing bed rotating element is capable of rotating the printing bed at various rotational speeds.

13. The additive manufacturing device according to claim 11, wherein the pump is capable of pumping the air through the air conduit toward the open end at various air pressures.

14. The additive manufacturing device according to claim 11, wherein:
the surface is formed to define the open end and additional open ends, and
the body is formed to define the air conduit terminating at the open end at the surface and being fluidly communicative with an exterior of the housing and additional air conduits terminating at corresponding ones of the additional open ends at the surface and being fluidly communicative with the exterior of the housing.

15. The additive manufacturing device according to claim 11, further comprising a modification arm, which is controllable by the controller, to manipulate a modification feature in multiple directions and with multiple degrees of freedom relative to the printing bed.

16. The additive manufacturing device according to claim 15, wherein the modification feature comprises one of a glass smoothing tool and a glass crimping tool.

17. The additive manufacturing device according to claim 15, further comprising a thermal management system configured to maintain the molten glass material in a molten state.

18. A method of automatically operating an additive manufacturing device, the method comprising:
printing molten glass material onto a printing bed;
rotating the printing bed;
pumping air into the molten glass material; and
manipulating the molten glass material into a predefined shape.

19. The method according to claim 18, further comprising maintaining the molten glass material in a molten state during the printing, the rotating, the pumping and the manipulating.

20. The method according to claim 18, wherein the manipulating comprises one or more of smoothing and crimping.
